(19) United States
(12) Patent Application Publication
(10) Pub. No.: US 2013/0208107 A1
(43) Pub. Date: Aug. 15, 2013

(54) Apparatus and a Method for Producing a Depth-Map

(71) Applicants: Matti Sakari HAMALAINEN, Lempaala (FI); Radu Ciprian Bilcu, Tampere (FI)

(72) Inventors: Matti Sakari HAMALAINEN, Lempaala (FI); Radu Ciprian Bilcu, Tampere (FI)

(73) Assignee: Nokia Corporation

(21) Appl. No.: 13/372,649

(22) Filed: Feb. 14, 2012

(51) Int. Cl. H04N 7/18; H04N 5/225

(52) U.S. Cl. 348/135; 348/340; 348/E05.024; 348/E07.085

(57) ABSTRACT

An apparatus including an image sensor; optics for the image sensor having optically symmetric characteristics about an optical axis; and an actuator configured to enable at least a first configuration and a second configuration, wherein in the first configuration the optical axis of the optics meets the image sensor at a first position and in the second configuration the optical axis of the optics meets the image sensor at a second position displaced from the first position.

### TECHNOLOGICAL FIELD

Embodiments of the present invention relate to an apparatus and a method for producing a depth-map.

### BACKGROUND

It is possible to produce a depth-map for a scene that indicates a depth to one or more objects in the scene by processing stereoscopic images. Two images are recorded at offset positions at different image sensors. Each image sensor records the scene from a different perspective. The apparent offset in position of an object between the images caused by the parallax effect may be used to estimate a distance to the object.

### BRIEF SUMMARY

According to various, but not necessarily all, embodiments of the invention there is provided an apparatus comprising: an image sensor; optics for the image sensor having optically symmetric characteristics about an optical axis; and an actuator configured to enable at least a first configuration and a second configuration of the optics, wherein in the first configuration the optical axis of the optics meets the image sensor at a first position and in the second configuration the optical axis of the optics meets the image sensor at a second position displaced from the first position.

According to various, but not necessarily all, embodiments of the invention there is provided an apparatus comprising a method comprising: at a first time, while imaging a first scene, controlling where an optical axis to meets an image sensor, such that the optical axis meets the image sensor at a first position on the image sensor; and at a second time, while imaging the first scene, controlling where the optical axis meets the same image sensor, such that the optical axis meets the image sensor at a second position on the image sensor different to the first position.

According to various, but not necessarily all, embodiments of the invention there is provided a non-stereoscopic method of producing a depth-map comprising: at a first time, while imaging a first scene, controlling where an optical axis meets an image sensor such that the optical axis meets the image sensor at a first position on the image sensor; at a second time, while imaging the first scene, controlling where the optical axis meets the same image sensor such that the optical axis meets the image sensor at a second position on the image sensor different to the first position; and using output from the image sensor at the first time and at the second time to produce a depth-map for the first scene.

### BRIEF DESCRIPTION

For a better understanding of various examples of embodiments of the present invention reference will now be made by way of example only to the accompanying drawings in which:

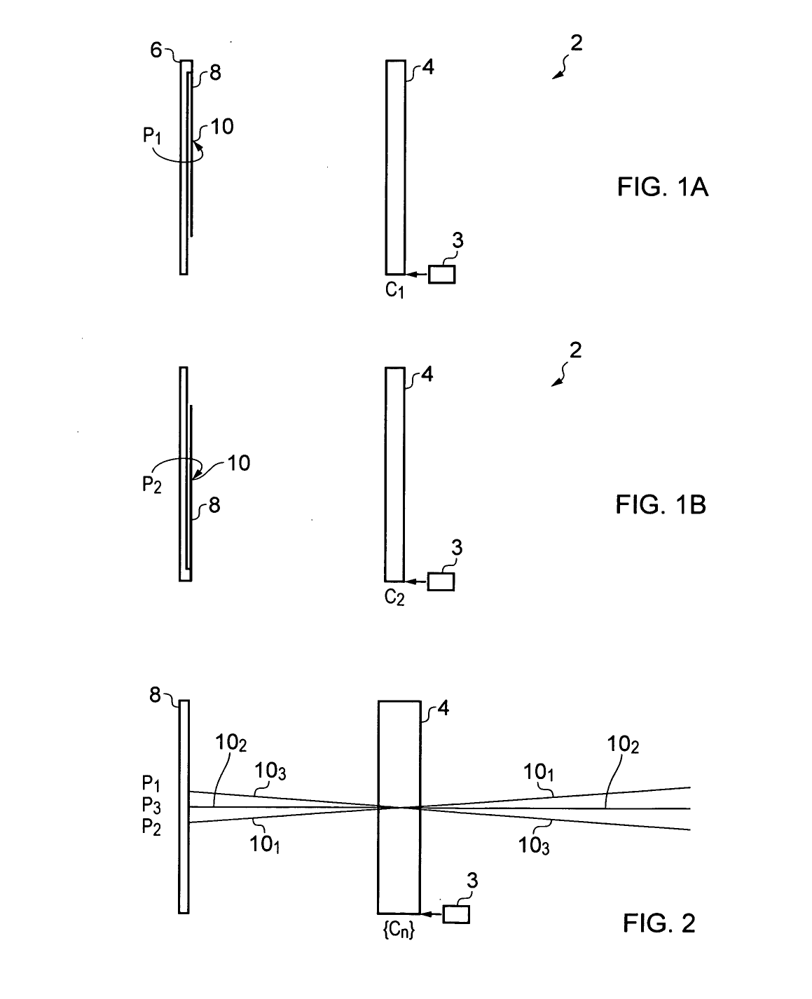

FIG. 1A illustrates an example of a first configuration of optics in an imaging apparatus;

FIG. 1B illustrates an example of a second configuration of optics in an imaging apparatus;

FIG. 2 illustrates as an example the different effects of different configurations of optics on an optical axis;

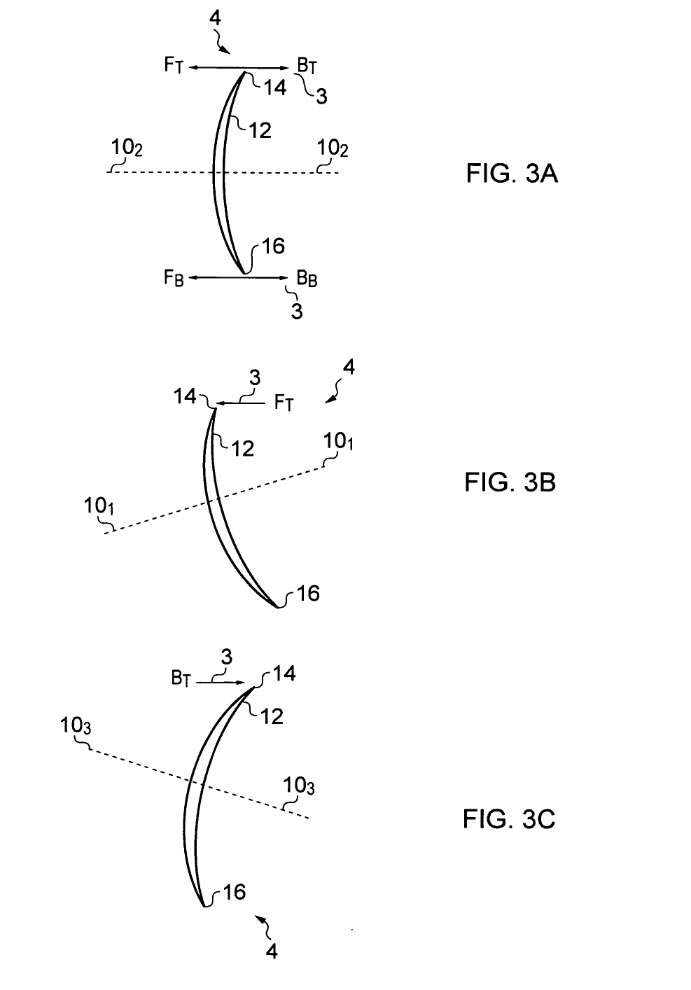

FIGS. 3A, 3B and 3C illustrate an example of optics in different configurations;

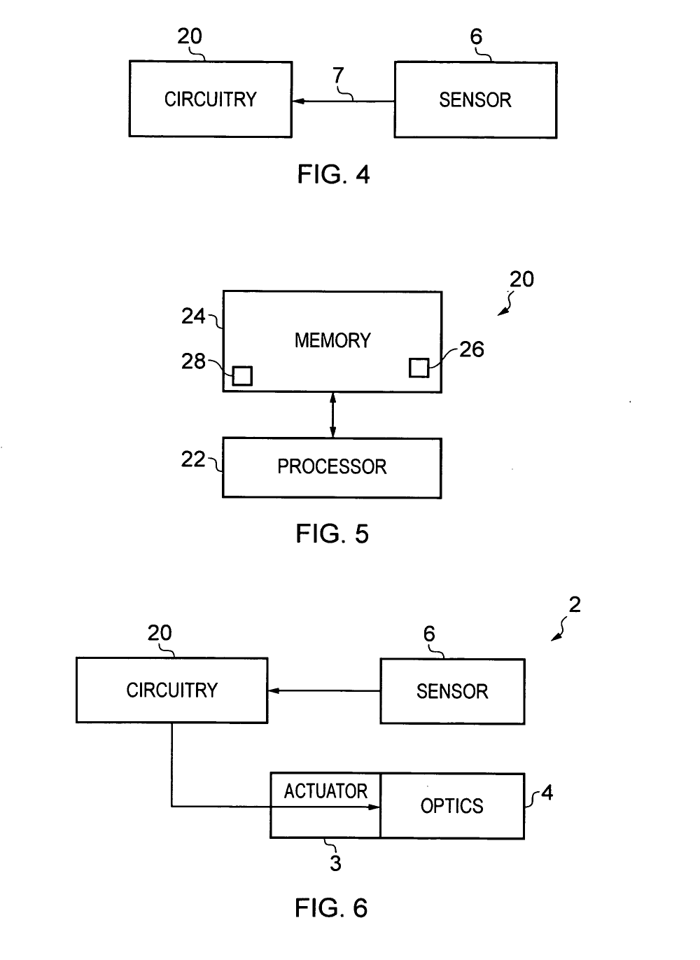

FIG. 4 illustrates an example of an image sensor and circuitry configured to produce a depth-map;

FIG. 5 illustrates an example of circuitry;

FIG. 6 illustrates an example of circuitry configured to control an actuator that changes a configuration of the optics;

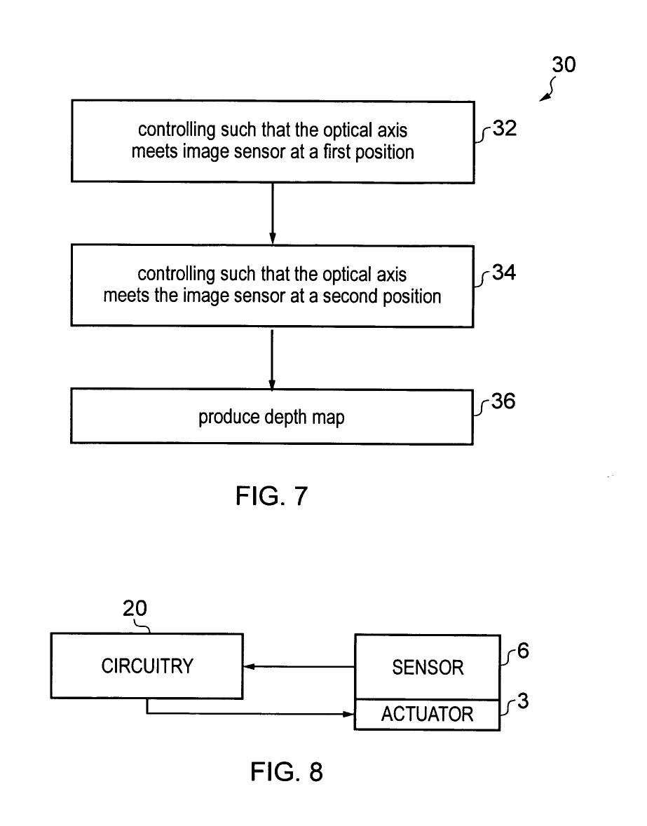

FIG. 7 illustrates a method of controlling optics for producing a depth-map; and

FIG. 8 illustrates an example of circuitry configured to control an actuator that changes a position of the image sensor.

### DETAILED DESCRIPTION

The Figures illustrate an imaging apparatus 2 comprising: an image sensor 6; optics 4 for the image sensor 6 having optically symmetric characteristics about an optical axis 10; and an actuator 3 configured to enable at least a first configuration c₁ of the optics 4 and a second configuration, wherein in the first configuration the optical axis 10 of the optics 4 meets the image sensor 6 at a first position p₁ and in the second configuration the optical axis 10 of the optics 4 meets the image sensor 6 at a second position p₂ displaced from the first position p₁.

In FIGS. 1A and 1B, 2 3A to 3C and 6 the first configuration and the second configuration enabled by the actuator 3 are a first configuration c₁ of the optics 4 and a second configuration c₂ of the optics. Whereas in FIG. 8, the first configuration and the second configuration enabled by the actuator 3 are a first configuration of the image sensor 6 and a second configuration of the image sensor 6.

FIGS. 1A and 1B illustrate an example of an imaging apparatus 2 comprising an image sensor 6, optics 4 for the image sensor 6 and an actuator 3.

The optics 4 have optically symmetric characteristics about an optical axis 10.

The actuator 3 is configured to enable at least a first configuration c₁ of the optics 4 and a second configuration c₂ of the optics.

FIG. 1A illustrates a first configuration c₁ of the optics 4. In this configuration, the optical axis 10 of the optics 4 meets the image sensor 6 at a first position p₁. An image 8 recorded at the image sensor 6 is centred at the first position p₁.

FIG. 1B illustrates a second configuration c₂ of the optics 4. In this configuration, the optical axis 10 of the optics 4 meets the image sensor 6 at a second position p₂ displaced from the first position p₁. An image 8 recorded at the image sensor 6 is centred at the second position p₂.

In this example, the image 8 centred at the first position p₁ and the image 8 centred at the second position p₂ are the same size.

The optical axis 10 is an imaginary straight line that defines a path along which light propagates through the optics 4. The optical axis 10 may pass through a centre of curvature of each optic surface within the optics, and may coincide with the axis of rotational symmetry.

The position where the optical axis 10 of the optics 4 meets the image sensor 6 changes between the first configuration c₁ of the optics 4 and the second configuration c₂ of the optics 4. This change in position may be achieved by moving the optical axis 10, for example, by translating the optical axis in a direction parallel to a plane of the image sensor 6 thereby changing the position where the optical axis 10 meets the plane of the image sensor 6 or by tilting the optical axis within a plane orthogonal to the plane of the image sensor 6. For clarity, the optical axis 10 is illustrated in FIGS. 1A and 1B only where it meets the image sensor 6 at positions p₁ and p₂.

The imaging apparatus 2 may, for example, be an electronic device or a module for incorporation within an electronic device. Examples of electronic device include dedicated cameras, devices with camera functionality such as mobile cellular telephones or personal digital assistants etc.

The image sensor 6 is a single image sensor 6. It may comprise in excess of 10 million pixels. It may, for example, comprise 40 million or more pixels where each pixel comprises a red, a green and a blue sub-pixel.

FIG. 2 illustrates an example of an imaging apparatus 2 similar to that illustrated in FIGS. 1A and 1B. In this example repositioning of where an optical axis 10 meets the image sensor 6 is controlled by tilting the optical axis 10 within a plane orthogonal to the plane of the image sensor 6 and parallel to the plane of the paper used for the illustration. The actuator 3 is configured to tilt the optical axis 10 to create different configurations with differently positioned optical axis 10₁, 10₂, 10₃.

In a first configuration c₁ of the optics 4, the optical axis 10₃ of the optics 4 is tilted clockwise (relative to orthogonal to the plane of the image sensor 8) at the optics 4 and meets the image sensor 6 at a first position p₁. The optical axis 10 of the optics 4 is displaced in a first direction from the centre of the image sensor 6.

In a second configuration c₂ of the optics 4, the optical axis 10₁ of the optics 4 is tilted counter-clockwise (relative to orthogonal to the plane of the image sensor 8) at the optics 4 and meets the image sensor 6 at a second position p₂. The optical axis 10 of the optics 4 is displaced in a second direction, opposite the first direction, from the centre of the image sensor 6.

In a third configuration c₃ of the optics 4, the optical axis 10₂ of the optics 4 is not tilted from orthogonal to the plane of the image sensor 8 and meets the image sensor 6 at a third position p₃. The optical axis 10 of the optics 4 is aligned with a centre of the image sensor 6.

FIGS. 3A, 3B and 3C illustrate an example of optics 4 in different configurations. The optics 4 is a lens system comprising one or more lens 12. Each lens 12 has optically symmetric characteristics about a common optical axis 10. In this example, the optics 4 comprises a single lens 12. However, in other examples of optics 4, the optics 4 may comprise a combination of multiple lenses.

The actuator 3 is configured to tilt the optical axis 10 to create different configurations of the optics 4 having differently positioned optical axis 10₁, 10₂, 10₃. In this example, tilting of the optical axis is achieved by physically tilting the optics 4. The actuator 3 is configured to tilt the optics 4 in a plane orthogonal to a plane of the image sensor 6 (not illustrated).

Referring to FIG. 3A, the actuator 3 is configured to operate in a first auto-focus mode to change a position where optical paths through the optics 4 are focused without changing where the optical axis 10 meets the image sensor 6. The actuator 3 is configured to symmetrically move a first side 14 of the optics 4 and a second side 16 of the optics 4 such that the optics 4 move through a rectilinear translation towards and away from the image sensor 6. The focal point of the optics 4 is therefore moved towards or away from the image sensor 6 but it does not move within the plane of the image sensor 6.

Referring to FIGS. 3B and 3C, the actuator 3 is configured to operate in a depth-map mode to change configurations of the optics 4 and hence a position where the optical axis 10 meets the image sensor 6.

In FIG. 3B, the actuator 3 is configured to asymmetrically cause relative movement between the first side 14 of the optics 4 and the second side 16 of the optics 4 such that the optical axis 10 tilts counter clockwise, at the optics 4, in a plane orthogonal to the plane of the image sensor 6.

In this example, the first side 14 of the optics 4 moves forwards towards the image sensor 6 more than the second side 16 (which may move forward, be stationary or move backwards) such that the optical axis 10 tilts counter clockwise in a plane orthogonal to the plane of the image sensor 6. In other examples, the second side 16 of the optics 4 may move backwards away from the image sensor 6 more than the first side 14 (which may move backwards, be stationary or move forwards) such that the optical axis tilts counter clockwise, at the optics 4, in a plane orthogonal to the plane of the image sensor 6.

In FIG. 3C, the actuator 3 is configured to asymmetrically cause relative movement between the first side 14 of the optics 4 and the second side 16 of the optics 4 such that the optical axis 10 tilts clockwise at the optics 4, in a plane orthogonal to the plane of the image sensor 6.

In this example, the first side 14 of the optics 4 moves backwards away from the image sensor 6 more than the second side 16 (which may move backwards, be stationary or move forwards) such that the optical axis tilts clockwise, at the optics 4, in a plane orthogonal to the plane of the image sensor 6. In other examples, the second side 16 of the optics 4 moves forwards towards the image sensor 6 more than the first side 14 (which may move forwards, be stationary or move backwards) such that the optical axis 10 tilts clockwise, at the optics 4, in a plane orthogonal to the plane of the image sensor 6.

The auto-focus mode and depth-map mode may both occur immediately prior to capturing an image. Capturing an image comprises recording the image and storing the image in an addressable data structure in a memory for subsequent retrieval.

FIG. 4 illustrates an example of circuitry 20 configured to produce a depth-map using output 7 from the image sensor 6 for different configurations.

In this example, the circuitry 20 is configured to produce a depth-map by comparing output 7 from the image sensor 6 for one configuration with output 7 from the image sensor 6 for another configuration. Typically, the actuator 3 enables the different configurations as a sequence.

The comparison may comprise:

defining an optical object comprising pixels;
matching pixels of a recorded image 8 output from the image sensor 6 for a first configuration c₁ which define an optical object with equivalent pixels of a recorded image 8 output from the image sensor 6 for the second configuration c₂ which define the same optical object from a different perspective;
for the first configuration, detecting a first location of the optical object within the sensor 6;
for the second configuration, detecting a second location of the optical object within the image sensor 6; then
using the first location and the second location to estimate a distance of the optical object from the image sensor 6.

The offset between the first location and the second location may be used to estimate a distance of the optical object corresponding to the matched pixels from the image sensor 6. For example, the circuitry 20 may access pre-stored calibration data 28 that maps the first location and the second location to a distance. The calibration data 28 may for example map a distance an imaged object moves with respect to the optical axis 10 when the optical axis 10 changes between the first position (first configuration) and the second position (second configuration) to a distance of the imaged object.

FIG. 6 illustrates an example of circuitry 20 configured to control the actuator 3 for reconfiguring the optics 4 and also configured to produce a depth-map as described with reference to FIG. 4.

In FIG. 6, the first configuration and the second configuration enabled by the actuator 3 are a first configuration of the optics 4 and a second configuration of the optics 4.

The circuitry 20 may adaptively control the actuator to change the configuration of the optics 4.

For example, the circuitry 20 may be configured to select, from multiple possible configuration of the optics 4, a pair of distinct configurations that obtain a maximum displacement between where an image of a particular object is sensed by the image sensor 6 for both configurations. The particular imaged object may have been selected by a user.

The circuitry 20 is configured to process output 7 from the image sensor 6 for two configurations to determine the pair of distinct configurations that better estimate a distance of the particular imaged object. The pair of distinct configurations may have opposite sense tilt (e.g. FIG. 3B, 3C).

FIG. 8 illustrates an example of circuitry 20 configured to control the actuator 3 for reconfiguring (repositioning) the image sensor 6 and also configured to produce a depth-map as described with reference to FIG. 4.

In FIG. 8, the first configuration and the second configuration enabled by the actuator 3 are a first configuration (position) of the image sensor 6 and a second configuration (position) of the image sensor 6.

The circuitry 20 may adaptively control the actuator to change the position of the image sensor 6 relative to the optics 4.

For example, the circuitry 20 may be configured to select, from multiple possible configurations, a pair of distinct configurations that obtain a maximum displacement between where on the image sensor 6 an image of a particular object is sensed by the image sensor 6 for both configurations. The particular imaged object may have been selected by a user.

The circuitry 20 is configured to process output 7 from the image sensor 6 for two configurations to determine the pair of distinct configurations that better estimate a distance of the particular imaged object.

FIG. 7 illustrates a method 30 of controlling optics 4 for producing a depth-map.

At block 32 at a first time, while imaging a first scene, the circuitry 20 controls where an optical axis 10 meets an image sensor 6 such that the optical axis meets the image sensor at a first position on the image sensor 6. The control may involve reconfiguration, to a first configuration, that changes the spatial relationship between the optical axis 10 and the image sensor 6. The control may, for example, involve the movement of the image sensor 6 and/or reconfiguration of the optics 4, such as for example, movement of one or more lenses 12.

At block 34 at a second time, while imaging the first scene, the circuitry 20 controls where the optical axis 10 to meets the same image sensor 6 such that the optical axis meets the image sensor at a second position on the image sensor 6 different to the first position. The control may involve reconfiguration, to a second configuration, that changes the spatial relationship between the optical axis 10 and the image sensor 6. The control may, for example, involve the movement of the image sensor 6 and/or reconfiguration of the optics 4, such as for example, movement of one or more lenses 12.

Then, at block 36, a depth-map may be produced. The output from the image sensor 6 at the first time and at the second time is used to produce a depth-map for the first scene. The method is a non-stereoscopic method because it uses a single image sensor that records at different times images produced by different configurations of the optics 4.

Implementation of the circuitry 20 can be in hardware alone (a circuit, a processor . . . ), have certain aspects in software including firmware alone or can be a combination of hardware and software (including firmware).

The circuitry may be implemented using instructions that enable hardware functionality, for example, by using executable computer program instructions in a general-purpose or special-purpose processor that may be stored on a computer readable storage medium (disk, memory etc) to be executed by such a processor.

FIG. 5 illustrates an example of circuitry 20. The circuitry 20 comprises at least one processor 22; and at least one memory 24 including computer program code the at least one memory 24 and the computer program code configured to, with the at least one processor 22, control at least partially operation of the circuitry 20 as described above.

The processor 22 and memory 24 are operationally coupled and any number or combination of intervening elements can exist (including no intervening elements)

The processor 22 is configured to read from and write to the memory 24. The processor 22 may also comprise an output interface via which data and/or commands are output by the processor 22 and an input interface via which data and/or commands are input to the processor 22.

The memory 24 stores a computer program 26 comprising computer program instructions that control the operation of the apparatus 2 when loaded into the processor 22. The computer program instructions 26 provide the logic and routines that enables the apparatus to perform the methods illustrated in FIG. 7 and described with reference to FIGS. 1A to 6. The processor 22 by reading the memory 24 is able to load and execute the computer program 26.

The apparatus 2 in this example therefore comprises: at least one processor 22; and at least one memory 24 including computer program code 26 the at least one memory 24 and the computer program code 26 configured to, with the at least one processor 22, cause the apparatus 2 at least to perform: at a first time, while imaging a first scene, controlling an optical axis 10 to meet an image sensor 6 at a first position on the image sensor 6; and at a second time, while imaging the first scene, controlling the optical axis 10 to meet the same image sensor 6 at a second position on the image sensor 6 different to the first position.

The at least one memory 24 and the computer program code 26 may be configured to, with the at least one processor 22, cause the apparatus 2 at least to additionally perform: using output from the image sensor 6 at the first time and at the second time to produce a depth-map 28 for the first scene.

The computer program 26 may arrive at the apparatus 2 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 26. The delivery mechanism may be a signal configured to reliably transfer the computer program 26. The apparatus 2 may propagate or transmit the computer program 26 as a computer data signal.

Although the memory 24 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

As used here ‘module’ refers to a unit or apparatus that excludes certain parts/components that would be added by an end manufacturer or a user.

The blocks illustrated in the FIG. 7 may represent steps in a method and/or sections of code in the computer program 26. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

For example, the measurement circuit may be used to measure a position of the optical system as a result of activation of the actuator 3. The measurement circuitry may be a part of the actuator or separate to the actuator 3. The measurement provides a feedback loop such that the circuitry 20 can accurately control the actual configuration of the optics 4.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
an image sensor;
optics for the image sensor having optically symmetric characteristics about an optical axis; and
an actuator configured to enable at least a first configuration and a second configuration, wherein in the first configuration the optical axis of the optics meets the image sensor at a first position and in the second configuration the optical axis of the optics meets the image sensor at a second position displaced from the first position.

2. An apparatus as claimed in claim 1 embodied in a camera module for an electronic device.

3. (canceled)

4. (canceled)

5. (canceled)

6. (canceled)

7. An apparatus as claimed in claim 1, further comprising circuitry configured to process output from the image sensor for the first configuration to define optical objects and configured to detect first positions of optical objects within the sensor, configured to process output from the image sensor for the second configuration to detect second positions of optical objects within the image sensor and configured to use the first positions and second positions to estimate distances of the optical objects from the image sensor.

8. (canceled)

9. (canceled)

10. An apparatus as claimed in claim 1, wherein in the first configuration the optical axis of the optics is aligned with a centre of the image sensor and in the second configuration the optical axis of the optics is displaced from the centre of the image sensor

11. An apparatus as claimed in claim 1, wherein in the first configuration the optical axis of the optics is displaced from a centre of the image sensor in a first direction and in the second configuration the optical axis of the optics is displaced from the centre of the image sensor in a second direction opposite to the first direction.

12. An apparatus as claimed in claim 11, further comprising circuitry configured to select the first configuration and the second configuration from multiple possible configurations to obtain a maximum displacement between where an image of a particular object is sensed by the image sensor for the first configuration and where an image of the particular object is sensed by the image sensor for the second configuration.

13. An apparatus as claimed in claim 1, wherein the first configuration and the second configuration enabled by the actuator are, respectively, a first configuration of the optics and a second configuration, of the optics.

14. An apparatus as claimed in claim 13, wherein the actuator is configured to enable at least a first configuration of the optics, a second configuration of the optics and a third configuration of the optics, wherein in the first configuration of the optics the optical axis of the optics meets the image sensor at a first position, in the second configuration of the optics the optical axis of the optics meets the image sensor at a second position displaced from the first position and in the third configuration of the optics the optical axis of the optics meets the image sensor at a third position displaced from the first position and the second position.

15. An apparatus as claimed in claim 14, wherein the circuitry is configured to process output from the image sensor for the second configuration of the optics to determine the third configuration of the optics.

16. An apparatus as claimed in claim 14, comprising user input configured to enable user selection of a particular imaged object and configured to determine at least the third configuration of the optics to better estimate a distance to the user-selected object.

17. An apparatus as claimed in claim 13, wherein in the first configuration of the optics the optical axis of the optics is aligned with a centre of the image sensor and in the second configuration of the optics the optical axis of the optics is displaced within the image sensor from a centre of the image sensor in a particular direction and
in the third configuration of the optics the optical axis of the optics is displaced within the image sensor from the centre of the image sensor in another direction opposite to the particular direction.

18. An apparatus as claimed in claim 1, wherein the actuator is configured to tilt the optical axis.

19. An apparatus as claimed in claim 1, wherein the actuator is configured to tilt the optics.

20. An apparatus as claimed in claim 1, wherein the actuator is configured to operate in a first auto-focus mode to change a position where optical paths through the optics are focused without changing where the optical axis meets the image sensor and is configured to operate in a second depth-map mode to change a position where the optical axis meets the image sensor.

21. An apparatus as claimed in claim 20, wherein the actuator is configured to symmetrically actuate the optics in the first auto-focus mode and asymmetrically actuate the optics in the second depth-map mode.

22. An apparatus as claimed in claim 21, wherein symmetrically actuating the optics comprises movement of a first side of the optics and a second side of the optics such that the optics move through a rectilinear translation and asymmetrically actuating the optics comprises independent movement of the first side of the optics relative to the second side of the optics such that the optics move through at least a partial tilt.

23. An apparatus as claimed in claim 20, wherein the first auto-focus mode and the second depth-map mode both occur immediately prior to capturing an image.

24. (canceled)

25. An apparatus as claimed in claim 1, wherein the image sensor is a single image sensor comprising in excess of 10 million pixels.

26. A method comprising:
at a first time, while imaging a first scene, controlling where an optical axis meets an image sensor, such that the optical axis meets the image sensor at a first position on the image sensor; and
at a second time, while imaging the first scene, controlling where the optical axis meets the same image sensor, such that the optical axis meets the image sensor at a second position on the image sensor different to the first position.

27. A non-stereoscopic method of producing a depth-map comprising:
at a first time, while imaging a first scene, controlling an optical axis to meet an image sensor at a first position on the image sensor;
at a second time, while imaging the first scene, controlling where an optical axis meets an image sensor, such that the optical axis meets the same image sensor at a second position on the image sensor different to the first position; and
using output from the image sensor at the first time and at the second time to produce a depth-map for the first scene.

28. (canceled)

29. (canceled)

30. (canceled)
